(19) United States
(12) Patent Application Publication
(10) Pub. No.: US 2005/0253970 A1
(43) Pub. Date: Nov. 17, 2005

(54) Projection television

(76) Inventor: Kyoung-choul Jang, Suwon-si (KR)

Correspondence Address: STANZIONE & KIM, LLP, 919 18TH STREET, N.W., SUITE 440, WASHINGTON, DC, 20006, US

(21) Appl. No.: 10/992,852

(22) Filed: Nov. 22, 2004

(30) Foreign Application Priority Data
May 13, 2004 (KR) 2004-33859

(51) Int. Cl. H04N 9/31

(52) U.S. Cl. 348/744

(57) ABSTRACT

A projection television including: a light source emitting light; a light source accommodator accommodating the light source; an optical engine unit disposed in front of the light source accommodator, and mounted with a light tunnel passing the light emitted from the light source there through; a light source housing mounted between the light source accommodator and the optical engine unit, and accommodating the light source accommodator; and a positioning part disposed between the light source accommodator and the optical engine unit, and defining a position of the light source with respect to the optical engine unit, and the positioning part comprising a positioning projection formed in one of the light source accommodator and the optical engine unit, and a positioning groove formed to correspond to the positioning projection in the other of the light source accommodator and the optical engine unit and coupled to the positioning projection. Thus, a projection television having a compact optical system capable of aligning a light-axis by positioning a light source is provided.

### CROSS-REFERENCE TO RELATED APPLICATIONS

This application claims the benefit of Korean Patent Application No. 2004-33859, filed Mar. 13, 2004, in the Korean Intellectual Property Office, the disclosure of which is incorporated herein in its entirety and by reference.

### BACKGROUND OF THE INVENTION

1. Field of the Invention

The present general inventive concept relates to a projection television, and more particularly, to a projection television comprising an improved optical system.

2. Description of the Related Art

Generally, a projection television displays a large-sized image by applying the principle of a projector projecting an image beam on a screen by using a mirror and an optical lens. The projection television is classified into a CRT (Cathode Ray Tube) type, an LCD (Liquid Crystal Display) type and a DLP (Digital Light Processing) type, etc., according to a display device displaying signal image information.

The projection television comprises a lamp, which functions as a light source, and an optical engine projecting the image beam on the screen by dividing and combining light emitted from the lamp.

Brightness and color of an image displayed on the screen is changed by a direction of the light emitted from the lamp, and therefore a stationary structure of the lamp firmly maintaining a state of the lamp is necessary.

A stationary structure of a lamp disclosed in Korean patent first publication No. 2002-0008922 comprises a lamp holder supporting a frame while maintaining a predetermined distance from the frame of the lamp, and a tension guide maintaining an exact center of a light-axis by elastically returning a position of the lamp to a predetermined position when the lamp is swayed.

With this configuration, the lamp is able to sway within a predetermined range so that cracks of a funnel or a neck due to heating of the lamp can be prevented. Also, a wrong positioned center of the light-axis is corrected because the lamp is elastically pushed by the tension guide.

However, although the lamp is fixed by a stationary means of the lamp, the center of the light-axis ends up in a wrong-position due to moving of the lamp holder.

### SUMMARY OF THE INVENTION

Accordingly, it is an aspect of the present general inventive concept to provide a projection television comprising a compact optical system capable of aligning a light-axis by positioning a light source.

Additional aspects and/or advantages of the general inventive concept will be set forth in part in the description which follows and, in part, will be obvious from the description, or may be learned by practice of the general inventive concept.

The foregoing and/or other aspects and advantages of the present general inventive concept are achieved by providing a projection television comprising: a light source emitting light; a light source accommodator accommodating the light source; an optical engine unit disposed in front of the light source accommodator, and mounted with a light tunnel passing therethrough the light emitted from the light source; a light source housing mounted between the light source accommodator and the optical engine unit, and accommodating the light source accommodator; and a positioning part disposed between the light source accommodator and the optical engine unit, and defining a position of the light source with respect to the optical engine unit, and the positioning part comprising a positioning projection formed in one of the light source accommodator and the optical engine unit, and a positioning groove formed to correspond to the positioning projection in the other of the light source accommodator and the optical engine unit and coupled to the positioning projection.

According to an aspect of the present general inventive concept, the light source accommodator comprises a side frame, and a front frame forming a predetermined angle with respect to the side frame, mounted with the light source, and formed with an opening passing the light from the light source therethrough.

According to an aspect of the present general inventive concept, the projection television may further comprise an engine housing accommodating the optical engine housing, and the positioning projection and the positioning groove may be respectively formed in the engine housing and the light source accommodator.

According to an aspect of the present general inventive concept, the light source housing may be formed with a through part so that the positioning projection is coupled to the positioning groove.

According to an aspect of the present general inventive concept, a light-axis of the light source is crossed with a center of the light tunnel when the light source accommodator is coupled to the optical engine unit, and the light-axis of the light source is aligned with a center of the light tunnel when the positioning projection is coupled to the positioning groove.

The foregoing and/or other aspects and advantages of the present general inventive concept are also achieved by providing a projection television comprising a light source emitting light; a light source accommodator accommodating the light source; and a light source housing disposed in front of the light source accommodator and accommodating the light source accommodator, and a coupling direction in which the light source accommodator is coupled to the light source housing and a light-axis of the light source forming a predetermined angle.

According to an aspect of the present general inventive concept, the projection television may further comprise a sliding projection formed in the light source accommodator, and a sliding groove formed in the light source housing and coupled to the sliding projection so as to couple the light source accommodator to the light source housing by sliding thereof.

According to an aspect of the present general inventive concept, the light source accommodator may comprise a side frame, and a front frame forming a predetermined angle with the side frame and mounted with the light source and formed with an opening passing the light from the light source therethrough.

According to an aspect of the present general inventive concept, the projection television may further comprise an engine housing disposed to correspond to a front side of the light source housing, and mounted with a light tunnel passing the light from the light source therethrough.

According to an aspect of the present general inventive concept, the projection television may further comprise a positioning part disposed between the light source accommodator and the engine housing, and positioning a position of the light source with respect to the engine housing.

According to an aspect of the present general inventive concept, the positioning part may comprise a positioning projection formed in one of the light source accommodator and the engine housing, and a positioning groove formed to correspond to the other of the light source accommodator and the engine housing and coupled to the positioning projection.

### BRIEF DESCRIPTION OF THE DRAWINGS

These and other aspects and advantages of the general inventive concept will become apparent and more readily appreciated from the following description of the embodiments, taken in conjunction with the accompany drawings of which:

FIG. 1 is a schematic view of a projection television according to an embodiment of the present general inventive concept;

FIG. 2 is a combined perspective view of an optical system comprising a lamp assembly and an optical engine unit of a projection television according to an embodiment of the present general inventive concept;

FIG. 3 is a partial perspective view of the optical system illustrated in FIG. 2;

FIG. 4 is a partial perspective view illustrating a lamp assembly, a light housing and an engine housing of a projection television, according to an embodiment of the present general inventive concept;

FIG. 5 is a perspective view illustrating a direction of a light-axis of a light source and a coupling direction of a light source accommodator and an engine housing according to an embodiment of the present general inventive concept; and

FIG. 6 is a combined perspective view illustrating a state in which a light source accommodator is coupled to an engine housing of a projection television, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

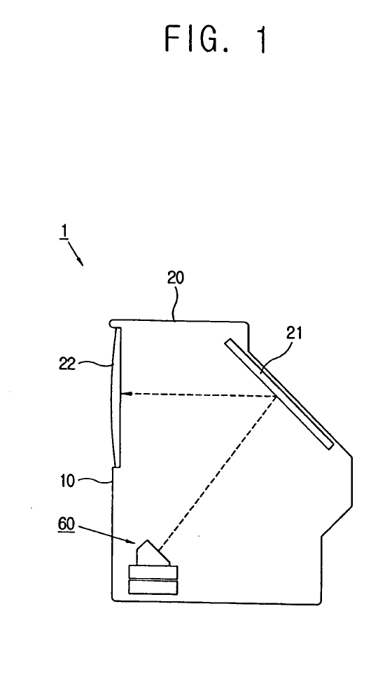

As shown in FIG. 1, a projection television 1 according to an embodiment of the present general inventive concept comprises a main body 10 including an optical engine unit 60 therein, and a displayer 20 provided on an upper part of the main body 10 and displaying an image on a screen 22 by an image beam projected from the optical engine unit 60 and then reflected by a reflecting mirror 21.

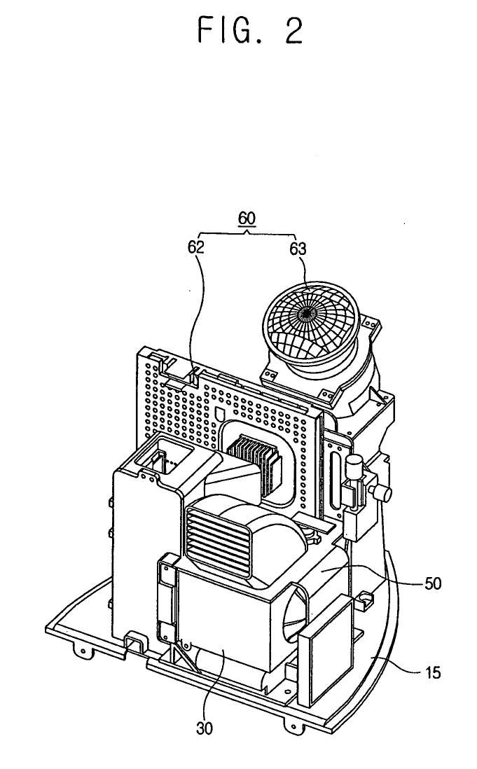

As shown in FIGS. 2 through 4, the main body 10 may comprise at an inside thereof a lamp assembly 30 including a light source 31 emitting light; a light source accommodator 40 accommodating the lamp assembly 30; a shield 49 provided in a back side of the light source accommodator 40 and protecting the light source 31; a light source housing 50 accommodating the light source accommodator 40 coupled to the lamp assembly 30; the optical engine unit 60 including a light tunnel 65, and projecting the image beam on a screen 22 by dividing and composing the light emitted from the lamp assembly 30; and an engine housing 70 accommodating the optical engine unit 60. These components are mounted on a base bracket 15 provided at a bottom of the main body 10. A positioning part 80, defining a position of the light source 31 with respect to the optical engine unit, is provided between the light source 31 and the optical engine unit 60.

The lamp assembly 30 may comprise the light source 31; a front supporter 32 coupled to a front side of the light source 31 and supporting the light source 31; and a back supporter 33 coupled to a back side of the light source 31 and supporting the light source 31.

Generally, the light source 31 may comprise an arc discharging lamp such as a Mercury Lamp, a Metal Halide Lamp or a Xenon Lamp, and the light source 31 may use other kinds of lamps.

The light source 31 may comprise the lamp 34 emitting light; a reflector 35 being coupled to the lamp 34 so as to enclose the lamp 34, and focusing the light by reflecting the light from the lamp 34; and a cover 36 provided in front of the lamp 34.

The front supporter 32 can be of a rectangular shape to correspond to the cover 36 of the light source 31, and is formed with a circle-shaped light passage 32a provided in a center of a front side thereof so that the light from the light source 31 is directed to the light tunnel 65. The front supporter 32 includes a skirt 37 bent from a circumference of the front supporter 32 toward the light source 31, and supporting the circumference of the light source 31 by contacting the light source 31.

A flange 38 can be projected on a side of the skirt 37 and can be formed with a coupling hole 38a to couple the front supporter 32 to the light source accommodator 40.

The back supporter 33 is formed with a reflector accommodator 33a at a center thereof so as to accommodate the approximately cone-shaped reflector 35, and supports the light source 31 by being coupled to the front supporter using a screw (not shown).

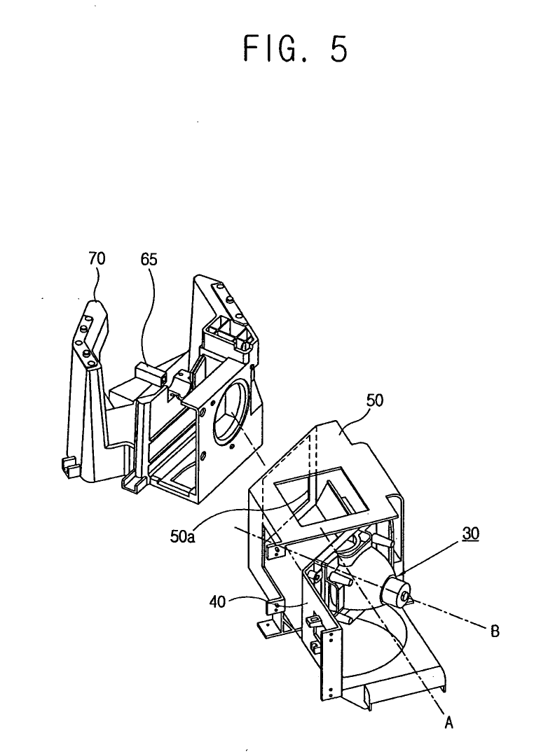

The light source accommodator 40 comprises an accommodator frame 41, and an accommodating space 42 so as to accommodate the light source 31 supported by the front supporter 32 and the back supporter 33. As shown in FIG. 5, when the light source accommodator 40 is coupled to a light source housing 50, a coupling direction A in which the light source accommodator 40 is coupled to the light source housing 50 and a light-axis B of the light source 31 forms a predetermined angle. More particularly, the accommodator frame 41 comprises a side frame 44, and a front frame 43 forming a predetermined angle to the side frame 44 and mounted with the lamp assembly 30. The accommodator frame 41 further comprises at a bottom thereof a bottom frame 45 coupled to the side frame 44 and the front frame 43. Accordingly, as shown in FIG. 2, the optical system comprising the lamp assembly 30 and the optical engine unit 60 becomes compact, so that an installing space inside of a main body 10 is minimized.

A front side of the front frame 43 is formed with an opening hole 43a passing therethrough the light from the light source 31, and a back side of the front frame 43 is formed with a flange contacting part 46 in contact with the flange 38 of the front supporter 32. The flange contacting part 46 is formed with a screw hole 46a coupled to a screw (not shown) to correspond to the coupling hole 38a of the flange 38.

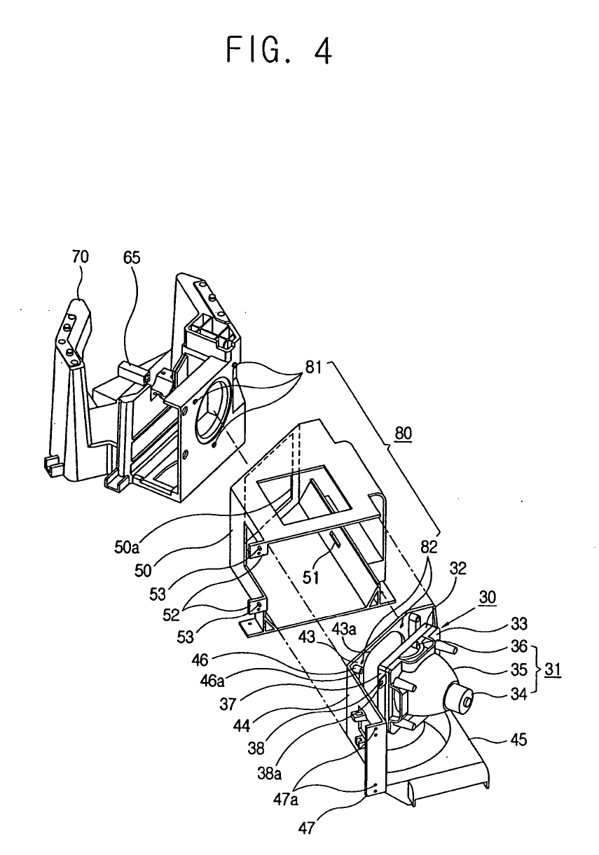

The side frame 44, bent to an outside of the accommodating space 42, comprises a coupling flange 47 (FIG. 4) coupled to the light source housing 50.

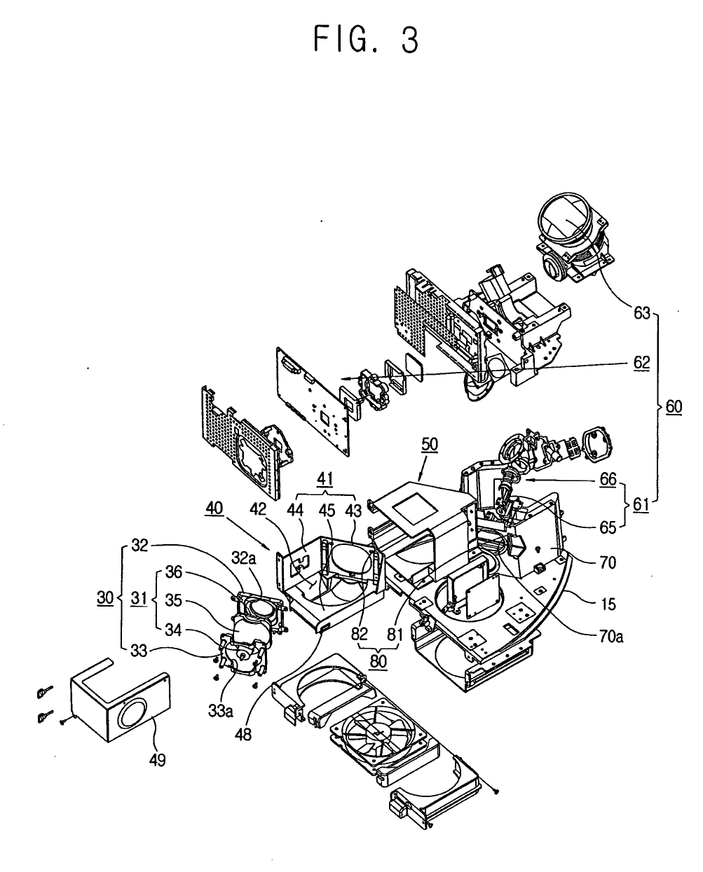

The bottom frame 45 is formed with a sliding projection 48 (FIG. 3) enabling the light source accommodator 40 to slide to the light source housing 50 at a side thereof.

The light source housing 50 is shaped to correspond to the light source accommodator 40 so as to accommodate the light source accommodator 40. The light source housing 50 is formed with a sliding groove 51 (FIG. 4) to be coupled to the sliding projection 48 of the light source accommodator 40 at opposite sides of a lower part thereof. An entrance part of the light source housing 50 is formed with a contacting flange 52 coupled to the coupling flange 47 of the light source accommodator 40, and a front side thereof is formed with a through part 50a so as to be coupled to the positioning part 80. The contacting flange 52 of the light source housing 50 is formed with a coupling projection 53, and the coupling projection 53 is inserted into a projection inserting hole 47a formed in the coupling flange 47 of the light source accommodator 40 so that the light source accommodator 40 is coupled to the light source housing 50.

When the light source accommodator 40 is sliding into the optical engine unit 60 to be coupled to the optical engine unit 60, the light-axis of the light source 31 is crossed with a center of the light tunnel 65. When the light source accommodator 40 is coupled to the optical engine unit 60 by the positioning part 80, the light-axis of the light source 31 is aligned with the center of the light tunnel 65.

The optical engine unit 60 may comprise an optical part 61, a panel 62 and a projecting lens 63 etc., and projects the image beam.

The optical part 61 is provided inside of the engine housing 70, and comprises a UV filter (not shown) selectively passing therethrough only visible light (λ=415 nm˜780 nm); the light tunnel 65 passing therethrough the light which passed through the UV filter; and a lens group 66 including a Dichroic Mirror and a Micro Lens etc., dividing and reflecting red (R), green (G) and blue (B) light which passed through the light tunnel 65 and then making the the red (R), green (G) and blue (B) light enter into only one pixel.

The panel 62 is provided with a DMD (Digital Micromirror Device). The DMD adjusts a reflecting angle per one pixel and modulates the image beam by using the light projected from the lens group 66.

The projecting lens 63 projects the image beam modulated at the panel 62 toward the reflecting mirror 21, and then the reflecting mirror 21 reflects the image beam to the screen 22 so that the image is displayed on the displayer 20.

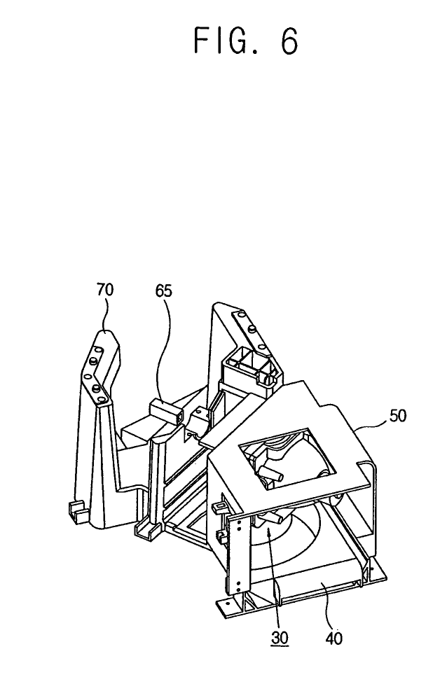

The positioning part 80 may comprise a positioning projection 81 formed in a front of the engine housing 70, and a positioning groove 82 formed in a front of the front frame 43 of the light source accommodator 40 mounted with the light source 31. The light source accommodator 40 mounted with the light source 31 is accommodated in the light source housing 50 by sliding into an inside of the light source housing 50. Then the positioning groove 82, formed at the light source accommodator 40, is coupled to the positioning projection 81 of the engine housing 70 by pushing the light source accommodator 40 so that the positioning projection 81 is coupled to the positioning groove 82. Thus, the positioning projection 81 is coupled to the positioning groove 82 through the through part 50a formed in a front of the light source housing 50, and at the same time, the coupling projection 53 of the engine housing 70 is inserted into the projection inserting hole 47a of the light source accommodator 40 so that the position of the light-axis of the lamp assembly 30 with respect to the optical engine unit 60 is defined (refer to FIG. 6). Accordingly, the light-axis B of the light source 31 is exactly aligned with the light tunnel 65 so that image quality, such as brightness, color, etc., of the image beam projected to the screen, is improved.

As described above, the positioning projection 81 and the positioning groove 82 of the positioning part 80 are respectively formed in the engine housing 70 and the light source accommodator 40. However, the position of these components may be respectively reversed.

A shape of the described positioning part 80 is not limited to that described and illustrated in the drawings, and is changeable in a range exactly positioning the light source 31 with respect to the optical engine unit 60.

The panel 62 is described above as comprising a DMD (Digital Micromirror Device), but may comprise an LCD (Liquid Crystal Display) or an LCOS (Liquid Crystal On Silicon) alternatively, or other types of devices that perform the required operations as described herein.

Although various embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A projection television comprising:
a light source emitting light;
a light source accommodator accommodating the light source;
an optical engine unit disposed in front of the light source accommodator and mounted with a light tunnel passing the light emitted from the light source there through;
a light source housing mounted between the light source accommodator and the optical engine unit, and accommodating the light source accommodator; and
a positioning part disposed between the light source accommodator and the optical engine unit, and defining a position of the light source with respect to the optical engine unit,
the positioning part comprising a positioning projection formed in one of the light source accommodator and the optical engine unit, and a positioning groove formed to correspond to the positioning projection in the other of the light source accommodator and the optical engine unit and coupled to the positioning projection.

2. The projection television according to claim 1, wherein the light source accommodator comprises:
a side frame; and
a front frame forming a predetermined angle with the side frame, having the light source mounted therein, and formed with an opening passing the light from the light source there through.

3. The projection television according to claim 2, further comprising an engine housing accommodating the optical engine unit, and
the positioning projection and the positioning groove are respectively formed in the engine housing and the light source accommodator.

4. The projection television according to claim 3, wherein the light source housing is formed with a through part in which the positioning projection is coupled to the positioning groove.

5. The projection television according to claim 1, wherein a light-axis of the light source crosses with a center of the light tunnel when the light source accommodator is being coupled to the optical engine unit, and the light-axis of the light source is aligned with the center of the light tunnel when the positioning projection is coupled to the positioning groove.

6. The projection television according to claim 2, wherein a light-axis of the light source crosses with a center of the light tunnel when the light source accommodator is being coupled to the optical engine unit, and the light-axis of the light source is aligned with the center of the light tunnel when the positioning projection is coupled to the positioning groove.

7. The projection television according to claim 3, wherein a light-axis of the light source crosses with a center of the light tunnel when the light source accommodator is being coupled to the optical engine unit, and the light-axis of the light source is aligned with the center of the light tunnel when the positioning projection is coupled to the positioning groove.

8. The projection television according to claim 4, wherein a light-axis of the light source crosses with a center of the light tunnel when the light source accommodator is being coupled to the optical engine unit, and the light-axis of the light source is aligned with the center of the light tunnel when the positioning projection is coupled to the positioning groove.

9. A projection television comprising:
a light source emitting light;
a light source accommodator accommodating the light source; and
a light source housing disposed in front of the light source accommodator and accommodating the light source accommodator,
a coupling direction in which the light source accommodator is coupled to the light source housing and a light-axis of the light source forming a predetermined angle.

10. The projection television according to claim 9, further comprising:
a sliding projection formed in the light source accommodator;
and a sliding groove formed in the light source housing and coupled to the sliding projection so as to couple the light source accommodator to the light source housing by sliding thereof.

11. The projection television according to claim 10, wherein the light source accommodator comprises:
a side frame; and
a front frame forming a predetermined angle with respect to the side frame and mounted with the light source and formed with an opening passing the light from the light source there through.

12. The projection television according to claim 9, further comprising an engine housing disposed to correspond to a front side of the light source housing, and mounted with a light tunnel passing the light from the light source there through.

13. The projection television according to claim 12, further comprising a positioning part disposed between the light source accommodator and the engine housing, and positioning a position of the light source with respect to the engine housing.

14. The projection television according to claim 13, wherein the positioning part comprises a positioning projection formed in one of the light source accommodator and the engine housing, and a positioning groove formed to correspond to the other of the light source accommodator and the engine housing and coupled to the positioning projection.

15. A projection television comprising:
a light source accommodator accommodating a light emitting source; and
a light source housing to accommodate the light source accommodator by sliding the light source accommodator therein such that the sliding direction of the light source accommodator with respect to the light source housing forms a predetermined angle with a light direction of the light being emitted from the light emitting source.

16. The projection television according to claim 15, further comprising:
an optical engine unit positioned in front of the light source accommodator and mounted with a light tunnel in which the emitted light passes; and
a positioning part provided between the light source accommodator and the optical engine unit to position the light source with respect to the optical engine unit.

17. The projection television according to claim 16, wherein the positioning part comprises:
a positioning projection formed in one of the light source accommodator and the optical engine unit; and
a positioning groove formed to correspond to the positioning projection in the other of the light source accommodator and the optical engine unit and coupled to the positioning projection.

18. The projection television according to claim 17, wherein a light-axis of the light source crosses a center of the light tunnel when the light source accommodator is being coupled to the optical engine unit, and the light-axis of the light source is aligned with the center of the light tunnel when the positioning projection is coupled to the positioning groove.

19. The projection television according to claim 17, further comprising an engine housing accommodating the optical engine unit, and the positioning projection and the positioning groove being respectively formed in the engine housing and the light source accommodator.

20. The projection television according to claim 15, wherein the light source accommodator comprises:
an accommodator frame including a side frame, a front frame forming a predetermined angle with the side frame and mounted to the lamp assembly, and a bottom frame coupled to the side frame and the front frame; and
an accommodating space to accommodate the light source.
